(19) United States
(12) Patent Application Publication
(10) Pub. No.: US 2011/0145052 A1
(43) Pub. Date: Jun. 16, 2011

(54) CONSUMPTION MANAGEMENT SYSTEMS AND METHODS INTEGRATED WITH SOCIAL NETWORKS

(76) Inventors: Sheng-Chun Lin, Taipei City (TW); Yu-Chuan Chang, Kaohsiung City (TW); Yu-Shiang Hung, Taipei City (TW)

(21) Appl. No.: 12/838,628

(22) Filed: Jul. 19, 2010

(30) Foreign Application Priority Data
Dec. 10, 2009 (TW) 098142211

(51) Int. Cl. G06Q 30/00; G06Q 99/00

(52) U.S. Cl. 705/14.27; 705/319

(57) ABSTRACT

Consumption management systems and methods integrated with social networks are provided. The system includes a member management system and a social network system. The member management system receives consumption data of a client, and generates a consumption message according to the consumption data. The member management system transmits the consumption message to the social network system via a network, such that the information regarding the consumption message is published for the client in the social network system.

### CROSS REFERENCE TO RELATED APPLICATIONS

This Application claims priority of Taiwan Patent Application No. 098142211, filed on Dec. 10, 2009, the entirety of which is incorporated by reference herein.

### BACKGROUND OF THE INVENTION

1. Field of the Invention

The disclosure relates generally to consumption management systems and methods integrated with social networks, and more particularly, to systems and methods that conveniently publish consumption information of users in the social network system.

2. Description of the Related Art

Along with the advanced development of internet access and resources, more and more network-related services and applications have been developed. For example, social network systems (SNS) or social network services can be set up based on networks, such that on-line societies can be created for users, such as online users. Social network services can provide an environment and interface means for users to contact, communicate, and interact with each other via networks. Examples of social network services include social websites, blogs, micrologs, chat rooms, email services, instant messaging, and others.

As another example, users can also sign up for memberships for rewards and benefits. As an example, a user can receive consumption bonus points by a business, for purchases in physical and/or online stores. Thus, consumption bonuses may be accumulated, so that certificates or discounts may be given for subsequent purchases.

In some cases, users may publish and share their purchase experiences in the social network systems, such that other users can refer to and make comments concerning the purchase experiences. In this regards, generally, users must manually login to a social network system to edit related messages for publishing. Accordingly, due to the complicated and time-consuming method for publishing, sharing and commenting on experiences online, such as purchasing experiences, some users may decide not to publish, share or comment on purchasing experiences, despite having a purchasing experience to share or comment on. Additionally, concerning accumulated consumption bonuses for memberships, the consumption bonuses can normally only be accumulated for an individual membership. Namely, there is no mechanism for associating purchasing decisions by one member with another member. However, if there were, such as, if one member is also rewarded with consumption bonus points, if another member makes a purchase based upon the member's purchasing experiences, then, more members would be motivated to share their purchasing experiences. Moreover, if more members share their purchasing experiences, product exposure would be increased along with purchasing activity due to the expanded means for accumulating consumption bonuses.

### BRIEF SUMMARY OF THE INVENTION

Consumption management systems and methods integrated with social networks are provided.

An embodiment of a consumption management system integrated with social networks includes a member management system and a social network system. The member management system records first consumption data of a first client, and generates a consumption message according to the first consumption data. The member management system transmits the consumption message to the social network system via a network, such that the information regarding the consumption message is published for the first client in the social network system.

In an embodiment of a consumption management method integrated with social networks, first consumption data of a first client is received. A consumption message is generated according to the first consumption data, and the consumption message is transmitted to the social network system via a network. After the consumption message is received, the information regarding the consumption message is published for the first client in the social network system.

An embodiment of a machine-readable storage medium comprises a computer program, which, when executed, causes a device to perform a consumption management method integrated with social networks. The method comprises steps of receiving first consumption data of a first client, generating a consumption message according to the first consumption data, transmitting the consumption message to the social network system via a network, and publishing the information regarding the consumption message for the first client in the social network system.

In some embodiments, the social network system includes data of a plurality of users who are grouped in a relationship, and the member management system further records second consumption data of a second client. It is determined whether the first client and the second client are grouped in a relationship in the social network system. If so, the member management system records a consumption bonus for the second client. In some embodiments, the member management system further records a publishing date of the consumption message and a consumption date of the second consumption data. It is determined whether the publishing date of the consumption message and the consumption date of the second consumption data are within a predefined interval. If so, the member management system records a consumption bonus for the first client or the second client.

In some embodiments, the social network system includes data of a plurality of users who are grouped in a relationship, and the users who and the first client are grouped in a relationship in the social network system are retrieved. The retrieved users are respectively notified with the information regarding the consumption message via the social network system. In some embodiments, the social network system further filters the retrieved users according to a filtering mechanism, and respectively notifies the filtered users with the information regarding the consumption message.

Consumption management methods integrated with social networks may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a consumption management system integrated with social networks of the invention;

FIG. 2 is a schematic diagram illustrating an embodiment of the structure of a member management system of the invention;

FIG. 3 is a flowchart of an embodiment of a consumption management method integrated with social networks of the invention; and

FIG. 4 is a flowchart of another embodiment of a consumption management method integrated with social networks of the invention.

### DETAILED DESCRIPTION OF THE INVENTION

Consumption management systems and methods integrated with social networks are provided.

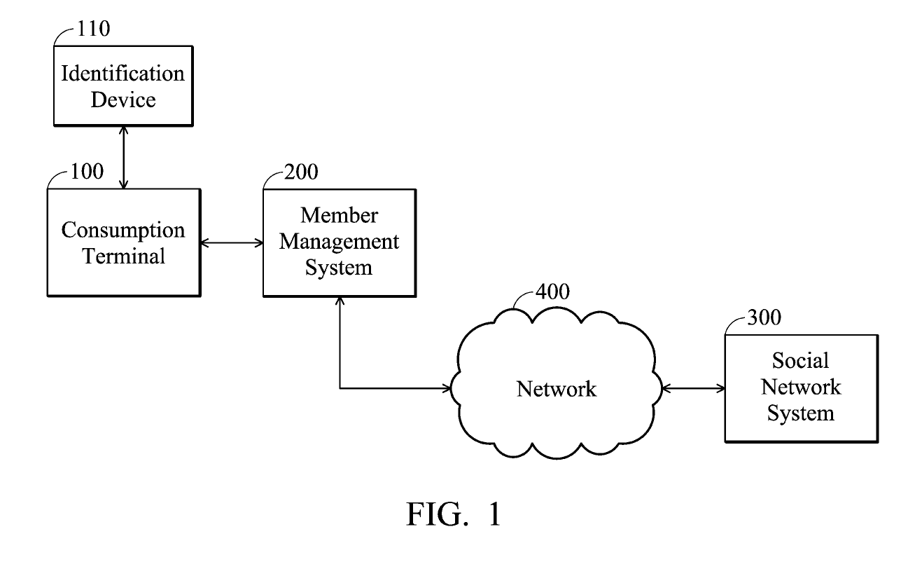

FIG. 1 is a schematic diagram illustrating an embodiment of a consumption management system integrated with social networks of the invention. It is understood that, the consumption of the invention comprises purchase of physical products, drinks, accommodations, and entertainment, provision of services, provision of information, or exchange of various valuable accumulated money/points/bonuses.

The consumption management system integrated with social networks comprises at least one consumption terminal 100, a member management system 200, and a social network system 300. In some embodiments, the consumption terminal 100 can be set up in a store for client consumption. The consumption terminal 100 may be a POS (Point Of Sale) terminal, a handheld POS terminal, a bill system, a cashier, a credit card machine, an information kiosk, or others. The consumption terminal 100 can be used for consumption of the client by using an identification device 110, such that corresponding consumption data is generated. It is understood that, in some embodiments, the identification device 110 may be a figure or an electronic figure comprising a storage media, and a card comprising an RFID (Radio-Frequency Identification), a 2-dimenesion/3-dimension barcode, or an IC (Integrated Circuit) chip for storing member identification data of the client in the member management system, user identification data of the client in the social network system, or the device data of the identification device. For example, a client may have a figure having a particular modeling, wherein the figure has an RFID for recording the member identification data of the client (and/or the user identification data in the social network system, and/or specific model/number of the figure). When the client performs consumption at the consumption terminal 110, the consumption terminal 110 can be equipped with an RFID reader to detect the RFID tag of the figure, and read related data. In other embodiments, the client can use an operational interface, such as a touch-sensitive screen/touch panel, a keyboard and a display interface, or a web page, set up or provided by the consumption terminal 110 or the member management system 200 to directly input the member identification data. It is noted that, in some embodiments, the consumption data at least records the identification data of the client, purchased product, store where purchase was made, the amount of money corresponding to the consumption, and/or consumption date. The consumption terminal 100 can couple to the member management system 200 to transmit the consumption data of the client to the member management system 200. The social network system 300 may be a system providing various social network services, such as email, instant message, friend match, blog, microblog, chat room, and other services. The social network system 300 may have data of a plurality of registered users storing in a user database (not shown in FIG. 1). The user database can be used to store user data, such as identification data of users, authentication data for login to the social network system 300, and/or a relationship of group, or called a group relationship among users. The relationship of group may be as a friend, a relative, a contact, or others.

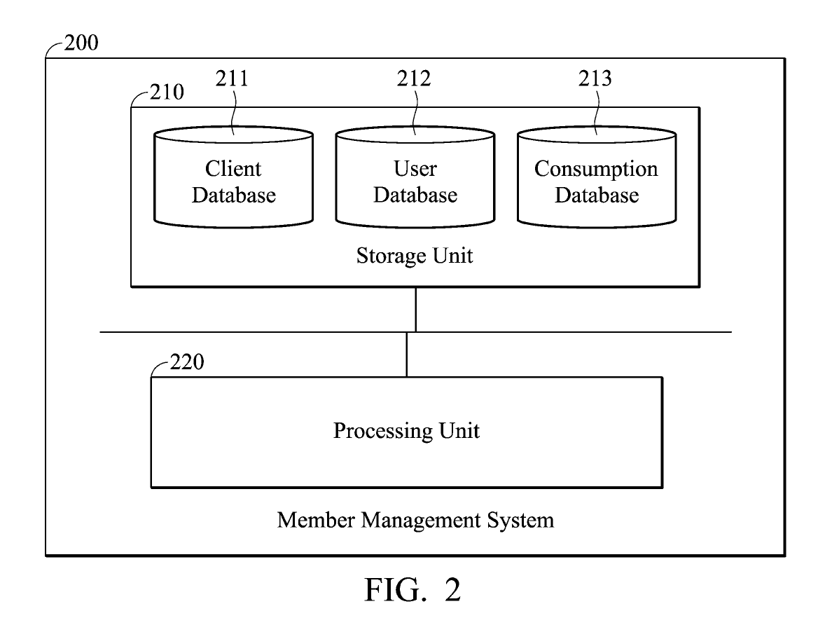

FIG. 2 is a schematic diagram illustrating an embodiment of the structure of a member management system of the invention.

The member management system 200 may be a processor-based electronic device, such as a computer, a server, and a workstation. The member management system 200 may be a commercial member management system, a consumption and bill system, a network shopping system, and/or a consumption bonus management system. The member management system 200 at least comprises a storage unit 210 and a processing unit 220. The storage unit 210 can comprise a client database 211, a user database 212, and a consumption database 213. The client database 211 records the member data, such as the identification data, authentication data, consumption data, and/or consumption bonus, such as bonus points of the respective client in the member management system 200. The user database 212 records the user data, such as the user identification data and the authentication data for login to the social network system 300, and/or the relationship of group among users in the social network system 300. It is understood that, in some embodiments, the user database 212 can be obtained and stored from the social network system 300 in advance. In some embodiments, the user database 212 does not have to be established in advance, and the social network system 300 is connected to retrieve related data when the data is needed. The consumption database 213 stores the consumption data received from the consumption terminal 100. Similarly, in some embodiments, the consumption data at least records the identification data of the client, purchased product, store where purchase was made, the amount of money corresponding to the consumption, and/or consumption date. It is understood that, in some embodiments, each consumption data can further record a publishing date corresponding to the consumption data to be published in the social network system 300. The generation and the application of the publishing date are discussed later. The processing unit 220 can control the operations of related hardware and software in the member management system 200, and perform the consumption management method integrated with social networks of the invention, which will be discussed further in the following paragraphs.

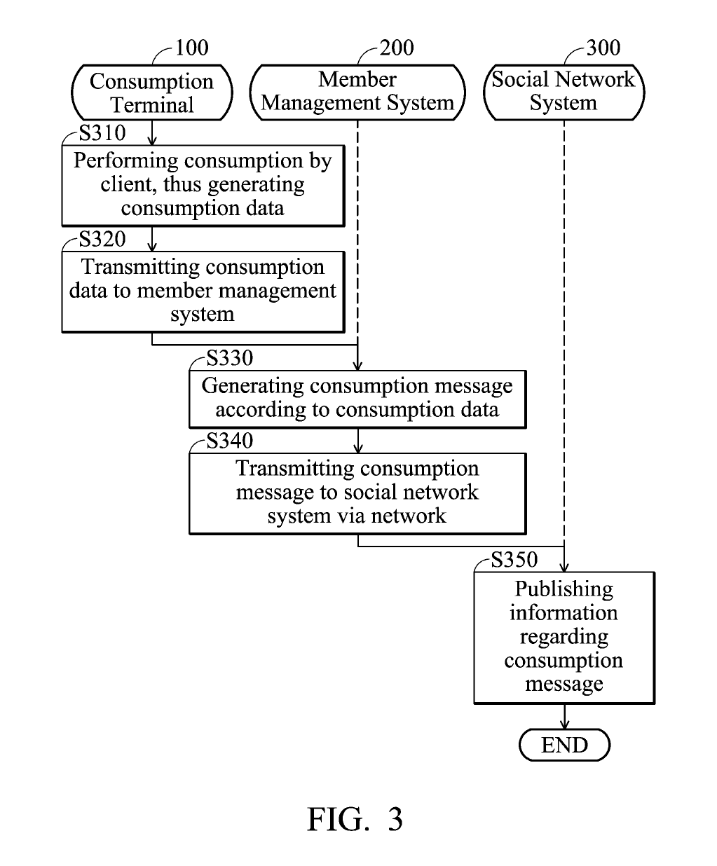

FIG. 3 is a flowchart of an embodiment of a consumption management method integrated with social networks of the invention. In this embodiment, the information regarding the consumption message of a client can be published to a social network.

In step S310, the consumption data is generated when a client performs consumption at the consumption terminal 100. In step S320, the consumption terminal 100 transmits the consumption data to the member management system 200. In some embodiments, the member management system 200 can record the consumption data. Additionally, in some embodiments, the member management system 200 can record a consumption bonus for the client according to the consumption data. For example, the member management system 200 can calculate a predefined percentage of the consumption money recorded in the consumption data as bonus money/points, and provide the bonus money/points to the client. In step S330, the member management system 200 generates a consumption message according to the consumption data. It is understood that, in some embodiments, the consumption message can be generated by transforming the consumption data into data conforming to a format of the service provided by the social network system 300. In some embodiments, a consumption message can be generated by first transforming the consumption data into data with a universal format, which is readable by general social network systems by the member management system 200, and transforming the data with the universal format into data conforming to the format of the service provided by the social network system 300 after the data with the universal format is received by the social network system 300. Then, in step S340, the consumption message is transmitted to the social network system 300 via a network. After the social network system 300 receives the consumption message, in step S350, the information regarding the consumption message is automatically published for the client in the social network system 300. It is understood that, in some embodiments, if a recognition and authentication process is required in the social network system 300, the member management system 200 can retrieve the user identification data and the authentication data of the client in the social network system 300 from the user database 212 for the recognition and authentication process, and publish the information regarding the consumption message in the social network system 300 according to the user identification data. In other embodiments, the user identification data and the authentication data can be also stored in the identity device, such as figure, such that the member management system 200 can directly retrieve the user identification data and the authentication data from the identity device.

As described, the social network system 300 may have data of a plurality of registered users. In some embodiments, the member management system 200 can determine whether the client recorded in the consumption data is one of the registered users in the social network system 300 according to the user database 212. When the client recorded in the consumption data is one of the registered users in the social network system 300, the member management system 200 transmits the consumption message to the social network system 300 via the network for publish. It is understood that, as described, the user database 212 can be obtained from the social network system 300 in advance, or be obtained from the social network system 300 when it is needed.

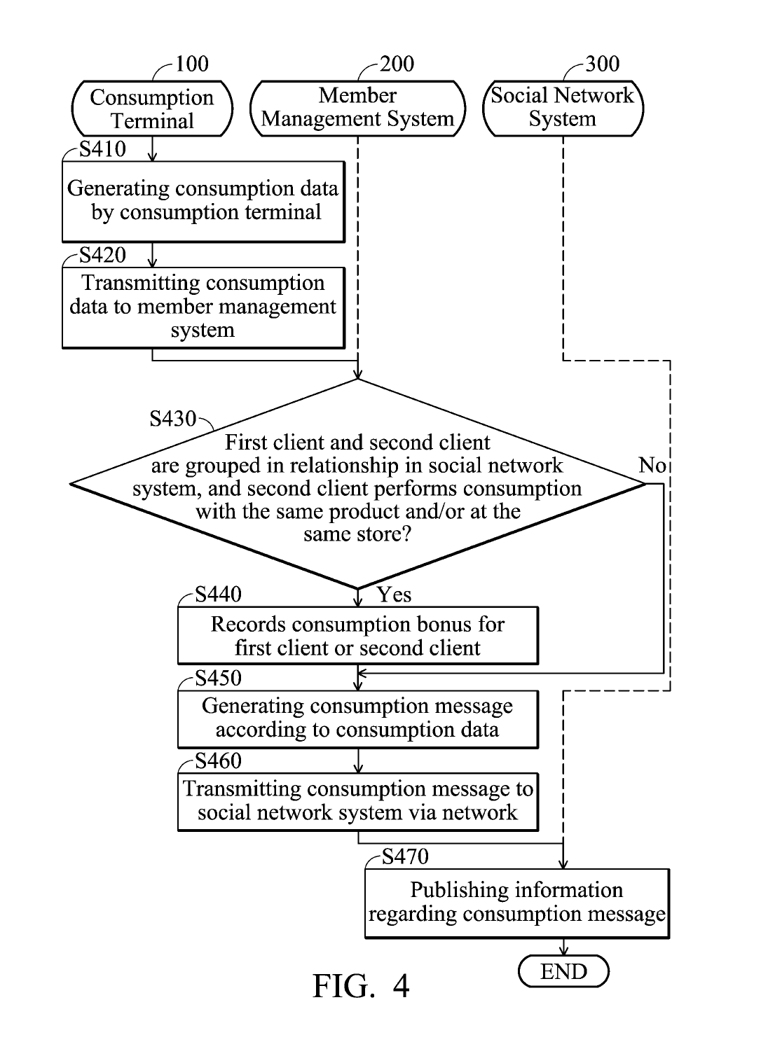

FIG. 4 is a flowchart of another embodiment of a consumption management method integrated with social networks of the invention. In this embodiment, the information regarding the consumption message of a client can be automatically published to a social network, and additional consumption bonuses may be generated according to consumption behavior of the other users who are grouped in a relationship, such as friends.

In step S410, consumption data is generated by a consumption terminal 100 when a first client performs consumption. In step S420, the consumption terminal 100 transmits the consumption data to the member management system 200. In some embodiments, the member management system 200 can record the consumption data, such as the first consumption data and second consumption data of at least a second client. Additionally, in some embodiments, the member management system 200 can record a consumption bonus for the client according to the consumption data. In step S430, the member management system 200 determines whether the first client and the second client are grouped in a relationship in the social network system according to the consumption database 213 and the user database 212. In some embodiments, the member management system 200 can further determine whether the second client, who and the first client are grouped in a relationship, performs the consumption with the same or other product/service at the same store. When the first client and the second client are not grouped in a relationship in the social network system or the second client, who and the first client are grouped in a relationship, does not perform the consumption with the same or other product/service at the same store (No in step S430), the procedure goes to step S450. When the first client and the second client are grouped in a relationship in the social network system and the second client, who and the first client are grouped in a relationship, performs the consumption with the same or other product/service at the same store (Yes in step S430), in step S440, the member management system 200 records a consumption bonus for the first client or the second client. It is understood that, in some embodiments, the member management system 200 can determine whether the consumption date of the first consumption data and the consumption date of the second consumption data are within a predefined interval, such as three days, one week or one month, according to the consumption date (or the publishing date of the consumption message to be published) of the first consumption data of the first client and the consumption date of the second consumption data of the second client. If the consumption date of the first consumption data and the consumption date of the second consumption data are within the predefined interval, the consumption bonus is recorded for the first client and/or the second client.

For example, the first client performs consumption at a specific store, such that the first consumption data recording the consumption date is accordingly generated. The information regarding the consumption message corresponding to the consumption data is published via the member management system 200 and the social network system 300, and the social network system 300 can transmit the publishing date of the information regarding the consumption message to be published to the member management system 200 for storage. When the second client performs consumption at the specific store, the member management system 200 also records the second consumption data and corresponding consumption date of the second client. The member management system 200 can further determine whether the first client and the second client are grouped in a relationship in the social network system 300 by using the consumption database 213 and the user database 212, or transmitting related data to the social network system 300 for related determination and receiving the determined result from the social network system 300. When the determined result shows that the first client and the second client are grouped in a relationship, and the consumption date of the first consumption data and the consumption date of the second consumption data are within a predefined interval such as one week, the member management system 200 provides an additional consumption bonus for the first client or the second client. In this way, the member management system 200 can encourage the first client to publish his consumption information, or encourage the second client to perform consumption at the same store based on the consumption information published by the first client, thus achieving advertisement and promotion objectives for products/stores. It is noted that, in some embodiments, when two clients perform consumption at different stores having a chain relationship, an alliance relationship, or a conglomerate relationship, the consumption of the two clients is determined at the same store. Additionally, when two clients perform consumption with different products (services) having the same series relationship, the same brand relationship, or a corresponding promotional relationship, the consumption of the two clients is determined with the same product (service).

Then, in step S450, the member management system 200 generates a consumption message according to the consumption data. Similarly, in some embodiments, the social network system 300 can provide at least one service. In step S450, the member management system 200 can transform the consumption data into a consumption message conforming to a format of the service provided by the social network system 300. Then, in step S460, the consumption message is transmitted to the social network system 300 via a network. After the social network system 300 receives the consumption message, in step S470, the information regarding the consumption message is automatically published for the client in the social network system 300.

As described, the social network system 300 may have data of a plurality of registered users. Similarly, in some embodiments, the member management system 200 can determine whether the client recorded in the consumption data is one of the registered users in the social network system 300 according to the user database 212. When the client recorded in the consumption data is one of the registered users in the social network system 300, the member management system 200 transmits the consumption message to the social network system 300 via the network for subsequent publish.

In some embodiments, if the social network system 300 can provide an active notification service, such as transmission of instant messages and/or emails for users who are grouped in a relationship, the users, who and the first client are grouped in a relationship, can be further retrieved in the social network system 300, and the retrieved users are respectively notified with the information regarding the consumption message via the social network system 300. For example, an instant message and/or an email regarding the consumption message/information is respectively transmitted to the users who are grouped in a relationship with the first client.

It is understood that, in some cases, each client may have a large amount of friends and relatives who are grouped in a relationship, and the consumption message can be transmitted to some filtered friends and relatives. That is, part of the friends and relatives can receive the consumption message. In some embodiments, the member management system 200 can filter the users who and the client are grouped in a relationship according to a filtering mechanism, and publish the information regarding the consumption message via the social network system 300, thus to respectively notify the filtered users with the information regarding the consumption message. It is understood that, in some embodiments, the filtering mechanism can be used to filter the users having the similar region, interest, consumption habit, and/or taste, and/or the by which users frequently contact with the client. In these embodiments, the member management system 200 can further determine whether a specific client is one of the filtered users based on the filtering mechanism. When the specific client is one of the filtered users based on the filtering mechanism, the member management system 200 can record a consumption bonus for the specific client.

Additionally, in some embodiments, a first client can use a first identification device, such as a figure A to perform consumption at a consumption terminal, such that the first consumption data and a first device data corresponding to the first identification device are recorded. The member management system 200 records second consumption data of a second client, wherein the second client can use a second identification device, such as a figure B to perform consumption at the consumption terminal, such that the second consumption data and a second device data corresponding to the second identification device are recorded. Then, the member management system 200 further determines whether the first client and the second client are grouped in a relationship based on the first device data and the second device data. For example, whether the figures have the same model, or whether the figures are in the same series of figures. If the first client and the second client are grouped in a relationship, a consumption bonus is recorded for the first client or the second client.

Therefore, the consumption management systems and methods integrated with social networks can automatically publish consumption experiences of users to social networks, and/or generate additional consumption bonuses according to consumption behaviors of friends. Further, users are encouraged to publish their consumption information, and friends are encouraged to perform consumption at the same store of the published consumption information based on the published consumption information, thus achieving advertisement and promotion for products/stores.

Consumption management methods integrated with social networks, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. When implemented on a general-purpose processor, the program code combines with the processor to provide a unique apparatus that operates analogously to the application of specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A consumption management system integrated with social networks, comprising:
a member management system recording first consumption data of a first client, and generating a consumption message according to the first consumption data, and transmitting the consumption message via a network; and
a social network system coupled with the member management system, receiving the consumption message from the member management system, and publishing the information regarding the consumption message for the first client in the social network system.

2. The system of claim 1, wherein the social network system comprises data of a plurality of users, and the member management system further determines whether data of the first client conforms to one of the user data of the social network system, and if the data of the first client conforms to one of the user data of the social network system, the member management system transmits the consumption message to the social network system via the network.

3. The system of claim 1, wherein a consumption terminal is used for the consumption of the first client, and transmits the first consumption data to the member management system via a network, wherein an identity device is used by the first client for consumption.

4. The system of claim 1, wherein the member management system further records a consumption bonus for the first client according to the first consumption data.

5. The system of claim 4, wherein the social network system comprises data of a plurality of users who are grouped in a relationship, and the member management system further records second consumption data of a second client, determines whether the first client and the second client are grouped in the relationship in the social network system, and if so, records a consumption bonus for the second client.

6. The system of claim 5, wherein the member management system further records a publishing date of the consumption message and a consumption date of the second consumption data, determines whether the publishing date of the consumption message and the consumption date of the second consumption data are within a predefined interval, and if so, records a consumption bonus for the first client or the second client.

7. The system of claim 5, wherein the member management system further records a consumption date of the first consumption data and a consumption date of the second consumption data, determines whether the consumption date of the first consumption data and the consumption date of the second consumption data are within a predefined interval, and if so, records a consumption bonus for the first client or the second client.

8. The system of claim 1, wherein the social network system comprises data of a plurality of users who are grouped in a relationship, retrieves the users who and the first client are grouped in a relationship in the social network system, filters the retrieved users according to a filtering mechanism, and notifies the filtered users with the information regarding the consumption message.

9. The system of claim 8, wherein the member management system further records second consumption data of a second client, determines whether the second client is one of the filtered users based on the filtering mechanism, and if so, records a consumption bonus for the second client.

10. The system of claim 1, wherein a consumption terminal is used for the consumption of the first client by using a first identity device, and the member management system records the first consumption data and first device data of the first identification device via the consumption terminal and a network, the member management system further records second consumption data of a second client, wherein a second identity device is used by the second client to perform consumption at a consumption terminal, and the member management system records the second consumption data and second device data of the second identification device via the consumption terminal and the network, and the member management system further determines whether the first device data and the second device data are grouped in a relationship, and if so, records a consumption bonus for the first client or the second client.

11. A consumption management method integrated with social networks, comprising:
receiving first consumption data of a first client;
generating a consumption message according to the first consumption data;
transmitting the consumption message to a social network system via a network; and
publishing the information regarding the consumption message for the first client in the social network system.

12. The method of claim 11, wherein the social network system comprises data of a plurality of users, wherein the method further comprises the steps of:
determining whether data of the first client conforms to one of the user data of the social network system; and
if the data of the first client conforms to one of the user data of the social network system, transmitting the consumption message to the social network system via the network.

13. The method of claim 11, further comprising:
providing a consumption terminal for the consumption of the first client; and
transmitting the first consumption data to the member management system via a network by the consumption terminal,
wherein an identity device is used by the first client for consumption.

14. The method of claim 13, wherein the identification device is a figure, and the figure comprises a storage media for storing member identification data of the first client in the member management system.

15. The method of claim 14, wherein the social network system comprises data of a plurality of users who are grouped in a relationship, wherein the method further comprises the steps of:
recording second consumption data of a second client;
determining whether the first client and the second client are grouped in the relationship in the social network system; and
if so, recording a consumption bonus for the second client.

16. The method of claim 15, further comprising:
recording a publishing date of the consumption message and a consumption date of the second consumption data;
determining whether the publishing date of the consumption message and the consumption date of the second consumption data are within a predefined interval; and
if so, recording a consumption bonus for the first client or the second client.

17. The method of claim 15, further comprising:
recording a consumption date of the first consumption data and a consumption date of the second consumption data;
determining whether the consumption date of the first consumption data and the consumption date of the second consumption data are within a predefined interval; and
if so, recording a consumption bonus for the first client or the second client.

18. The method of claim 11, wherein the social network system comprises data of a plurality of users who are grouped in a relationship, wherein the method further comprises the steps of:
retrieving users who and the first client are grouped in a relationship in the social network system;
filtering the retrieved users according to a filtering mechanism; and
notifying the retrieved users with the information regarding the consumption message.

19. The method of claim 18, further comprising:
recording second consumption data of a second client;
determining whether the second client is one of the filtered users based on the filtering mechanism; and
if so, recording a consumption bonus for the second client.

20. The method of claim 11, further comprising:
providing a first identity device to be used by the first client for consumption terminal at a consumption terminal, and recording the first consumption data and first device data of the first identification device via the consumption terminal and a network;
recording second consumption data of a second client, wherein the second client uses a second identity device to perform consumption at a consumption terminal, and recording the second consumption data and second device data of the second identification device via the consumption terminal and the network;
determining whether the first client and the second client are grouped in a relationship based on the first device data and the second device data; and
if so, recording a consumption bonus for the first client or the second client.

21. A machine-readable storage medium comprising a computer program, which, when executed, causes a device to perform a consumption management method integrated with social networks, wherein the method comprises:
receiving first consumption data of a first client;
generating a consumption message according to the first consumption data;
transmitting the consumption message to a social network system via a network; and
publishing the information regarding the consumption message for the first client in the social network system.
